(19) United States
(12) Patent Application Publication
(10) Pub. No.: US 2018/0060548 A1
(43) Pub. Date: Mar. 1, 2018

(54) IMAGE PROCESSING APPARATUS

(71) Applicant: KYOCERA Document Solutions Inc., Osaka (JP)

(72) Inventor: Masayuki Yamashirodani, Osaka (JP)

(21) Appl. No.: 15/688,638

(22) Filed: Aug. 28, 2017

(30) Foreign Application Priority Data
Aug. 29, 2016 (JP) 2016-166746

(51) Int. Cl. G06F 21/31; G06F 21/34; G06F 21/80

(52) U.S. Cl. CPC G06F 21/316; G06F 21/34; H04N 1/4426; H04N 2201/0094; G06F 21/80

(57) ABSTRACT

An image processing apparatus includes a reader, an authentication processor, and a process executor. The reader is configured to detect authentication medium in which authentication information is stored or displayed and read the authentication information from the authentication medium. The authentication processor is configured to execute user authentication on the basis of the authentication information read by the reader. The process executor is configured to, when the same authentication medium has been detected by the reader multiple times in a predetermined detection pattern, execute a preset process associated with the detection pattern.

### INCORPORATION BY REFERENCE

This application is based upon and claims the benefit of priority from the corresponding Japanese Patent Application No. 2016-166746 filed on Aug. 29, 2016, the entire contents of which are incorporated herein by reference.

### BACKGROUND

The present disclosure relates to an image processing apparatus capable of executing user authentication by using an authentication medium such as an IC card.

An image forming apparatus has been known which is capable of executing user authentication by using an authentication information providing medium (hereinafter, only referred to as “authentication medium”), such as an IC card, in which authentication information such as user ID is stored.

The image forming apparatus determines, by communicating with the authentication medium, whether or not a user holding the authentication medium is close to the image forming apparatus, and executes a print job of the user only when the user is close to the image forming apparatus. This makes it possible to prevent a printed matter having high confidentiality from being seen by others.

### SUMMARY

An image processing apparatus according to one aspect of the present disclosure includes a reader, an authentication processor, and a process executor. The reader is configured to detect authentication medium in which authentication information is stored or displayed and read the authentication information from the authentication medium. The authentication processor is configured to execute user authentication on the basis of the authentication information read by the reader. The process executor is configured to, when the same authentication medium has been detected by the reader multiple times in a predetermined detection pattern, execute a preset process associated with the detection pattern.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image processing apparatus according to an embodiment of the present disclosure.

FIG. 2 is a view illustrating the appearance of the image processing apparatus according to the embodiment of the present disclosure.

FIG. 3 is a diagram showing an example of card operation information used in the image processing apparatus according to the embodiment of the present disclosure.

FIG. 4 is a flowchart showing an example of procedures of card operation processing executed by the image processing apparatus according to the embodiment of the present disclosure.

FIG. 5 is a graph showing an example of a detection pattern detected by the image processing apparatus according to the embodiment of the present disclosure.

FIG. 6 is a graph showing another example of a detection pattern detected by the image processing apparatus according to the embodiment of the present disclosure.

FIG. 7 is a table showing an example of a job queue used in the image processing apparatus according to the embodiment of the present disclosure.

FIG. 8 is a table showing another example of the job queue used in the image processing apparatus according to the embodiment of the present disclosure.

FIG. 9 is a table showing a still another example of the job queue used in the image processing apparatus according to the embodiment of the present disclosure.

FIG. 10 shows an example of a card operation list screen used in the image processing apparatus according to the embodiment of the present disclosure.

FIG. 11 is a graph showing an example of a detection pattern detected by the image processing apparatus according to a modification of the present disclosure.

FIG. 12 is a graph showing another example of a detection pattern detected by the image processing apparatus according to the modification of the present disclosure.

FIG. 13 is a graph showing a still another example of a detection pattern detected by the image processing apparatus according to the modification of the present disclosure.

FIG. 14 is a table showing an example of a job queue used in the image processing apparatus according to the modification of the present disclosure.

### DETAILED DESCRIPTION

Hereinafter, embodiments of the present disclosure will be described with reference to the accompanying drawings in order to allow understanding of the present disclosure. It is noted that the following embodiment is an example embodying the present disclosure and does not limit the technical scope of the present disclosure.

### Configuration of Image Processing Apparatus

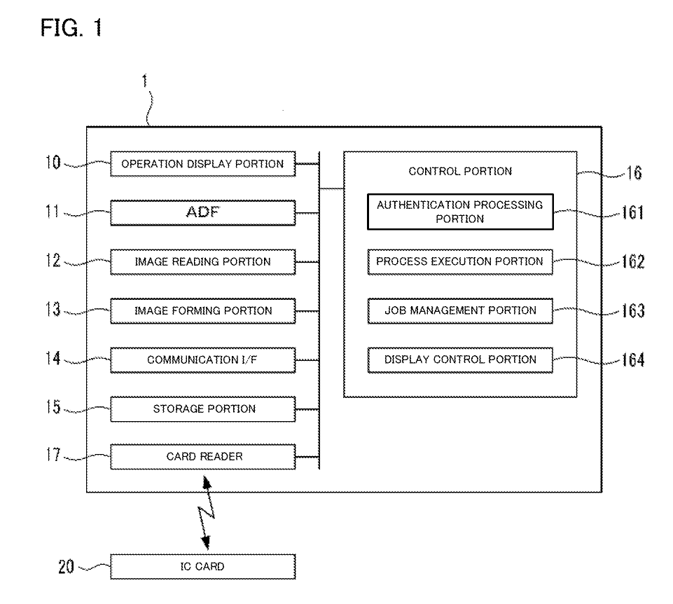

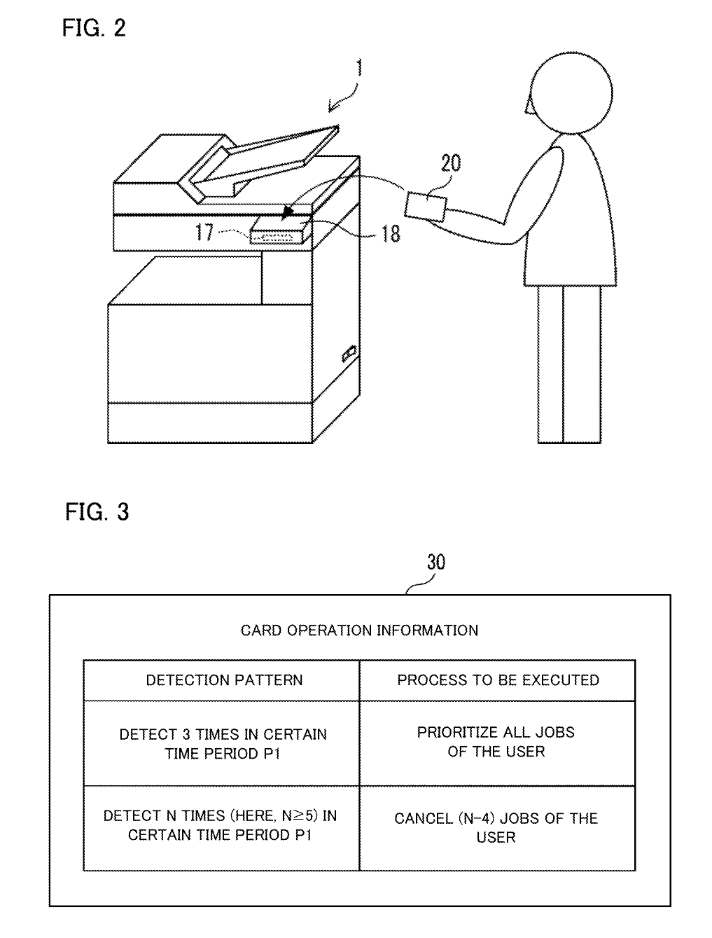

As shown in FIG. 1 and FIG. 2, an image processing apparatus 1 according to an embodiment of the present disclosure includes an operation display portion 10, an auto document feeder (ADF) 11, an image reading portion 12, an image forming portion 13, a communication I/F 14, a storage portion 15, a control portion 16, a card reader 17 (an example of a “reading portion” of the present disclosure), and the like. Specifically, the image processing apparatus 1 is a multifunction peripheral having a printer function, a scanner function, a copy function, a facsimile function, and the like. It is noted that the present disclosure is applicable to not only a multifunction peripheral but also any image processing apparatus such as a copy machine, a printer, and a facsimile apparatus.

The operation display portion 10 includes: a display portion, such as a liquid crystal display, which displays information; and an operation portion, such as a touch panel and an operation button, which receives user operations.

The ADF 11 includes a document set portion, a conveyance roller, a document holder, and a sheet discharge portion, and is an automatic document feeder that conveys a document to be read by the image reading portion 12.

The image reading portion 12 includes a document table, a light source, a mirror, an optical lens, and a charged coupled device (CCD), and is capable of reading an image from a document and outputting the read image as image data.

The image forming portion 13 is capable of performing a printing process based on image data by using an electrophotography method or an inkjet method, and forms an image on a sheet on the basis of the image data. For example, when the image forming portion 13 is an image forming portion that uses an electrophotography method, the image forming portion 13 includes a photosensitive drum, a charging device, an exposure device, a developing device, a transfer device, a fixing device, and the like.

The communication I/F 14 is a communication interface capable of performing a communication process in accordance with a predetermined communication protocol with an external information processing apparatus such as a facsimile apparatus or a personal computer, via a communication network such as a telephone line, the internet, or a LAN.

The storage portion 15 is a non-volatile storage portion such as a hard disk, or EEPROM (registered trademark). The storage portion 15 stores various control programs to be executed by the control portion 16, various kinds of data, and the like.

The control portion 16 includes control devices such as a CPU, a ROM, and a RAM. The CPU is a processor that executes various kinds of operational processing. The ROM is a non-volatile storage portion in which information such as a control program for causing the CPU to execute the various kinds of processing is previously stored. The RAM is a volatile or non-volatile storage portion used as a temporary storage memory (working area) for the various kinds of processing executed by the CPU.

Specifically, the control portion 16 includes an authentication processing portion 161, a process execution portion 162, a job management portion 163, and a display control portion 164. It is noted that the control portion 16 functions as the processing portions by executing various processes in accordance with the control program. The control portion 16 may include an electronic circuit that achieves a part or a plurality of processing functions of each processing portion.

The card reader 17 is capable of reading authentication information, such as user ID, from an IC card 20 (an example of an “authentication medium” of the present disclosure) held by a user through non-contact communication such as near field communication (NFC). As shown in FIG. 2, the card reader 17 is embedded in a card placement table 18 provided at an upper portion of the image processing apparatus 1. When the user holds the IC card 20 so as to come into contact with or be close to the card placement table 18, the card reader 17 detects the IC card 20 and reads the authentication information stored in the IC card 20.

The authentication processing portion 161 executes user authentication on the basis of the authentication information read by the card reader 17. By holding the IC card 20 held by the user over the card reader 17 (the card placement table 18), the user can log in to the image processing apparatus 1 and start using the image processing apparatus 1.

The IC card 20 is not limited to a non-contact type and may be a contact type. Instead of the configuration in which the authentication information stored in the IC card 20 is read by the card reader 17, for example, the configuration in which the authentication information displayed on the card as a barcode is read by a barcode reader (another example of the “reading portion” of the present disclosure) may be employed.

The IC card 20 is generally used to execute the user authentication as described above. Therefore, generally, when wishing to perform a desired operation on the image processing apparatus 1, a user needs to perform the desired operation through the operation display portion 10 after the user authentication by the IC card 20 has been executed. Meanwhile, with the image processing apparatus 1 according to the present embodiment, due to a configuration and operation described later, the user is allowed to perform at least a part of the desired operation by using the IC card 20.

When the same IC card 20 has been detected by the card reader 17 multiple times in a predetermined detection pattern, the process execution portion 162 executes a preset process associated with the detection pattern. Specifically, when the same IC card 20 has been detected by the card reader 17 multiple times in any of a plurality of predetermined detection patterns, the process execution portion 162 selects, from among a plurality of preset processes, the process associated with the detection pattern and executes the process. For example, the process execution portion 162 executes the process associated with the detection pattern on the basis of card operation information 30 shown in FIG. 3. The card operation information 30 is stored previously in, for example, the ROM or the storage portion 15. Determination as to whether the IC card 20 is the same IC card 20 can be made on the basis of the authentication information read from the IC card 20.

The process to be executed in accordance with the detection pattern by the process execution portion 162 may be, for example, a process related to the user who is associated with the authentication information read by the card reader 17. For example, the process to be executed in accordance with the detection pattern by the process execution portion 162 may include a process of changing priorities of jobs of the user who is associated with the authentication information read by the card reader 17, among unfinished jobs to be done by the image processing apparatus 1. Alternatively, the process to be executed in accordance with the detection pattern by the process execution portion 162 may include a process of cancelling jobs of the user who is associated with the authentication information read by the card reader 17, among unfinished jobs to be done by the image processing apparatus 1.

The job management portion 163 manages unfinished jobs to be done by the image processing apparatus 1. The job management portion 163 manages the priorities of unfinished jobs to be done by the image processing apparatus 1 by using, for example, a job queue 40 shown in FIG. 7. The job queue 40 is stored, for example, in the storage portion 15. When a new job is inputted to the image processing apparatus 1, the job is added to the job queue 40. The unfinished jobs stored in the job queue 40 are sequentially executed in descending order based on priority. In other embodiments, the job management portion 163 may be provided in a server device capable of communicating with the image processing apparatus 1. In this case, the image processing apparatus 1 may sequentially obtain, from the server device, the unfinished jobs in the job queue 40 stored in the server device and may execute the unfinished jobs in descending order based on priority.

The display control portion 164 displays various kinds of information on the operation display portion 10, and displays an operation screen for operating the image processing apparatus 1 and the like.

### Card Operation Processing

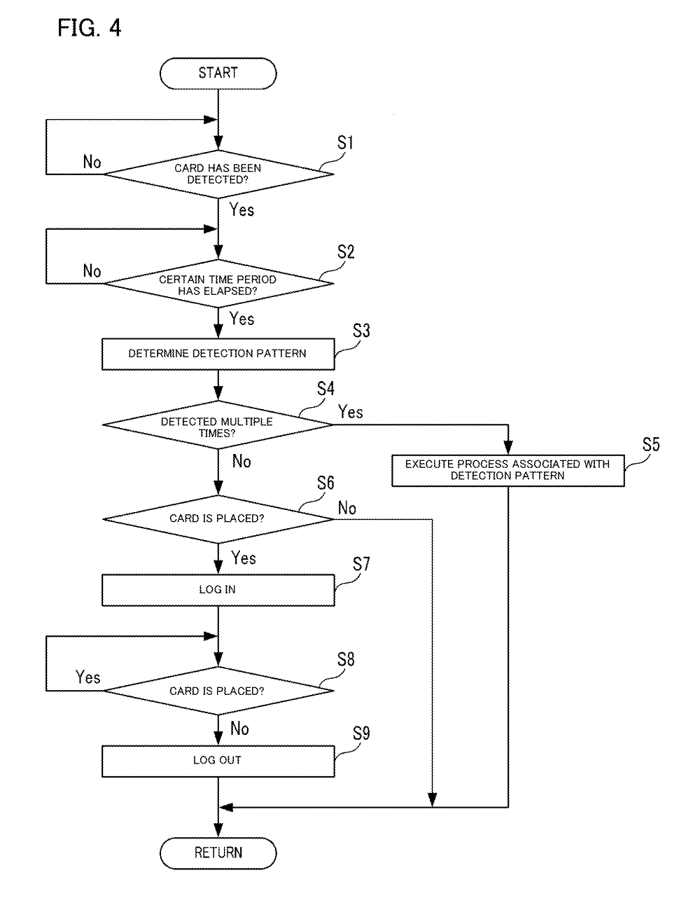

Next, with reference to FIG. 4, an example of procedures of card operation processing executed by the control portion 16 will be described. Here, steps S1, S2, and so on represent numbers of process procedures (steps) executed by the control portion 16. The card operation processing starts, for example, when the image processing apparatus 1 is turned on and ends when the image processing apparatus 1 is turned off.

### Step S1

First, in step S1, the control portion 16 determines, on the basis of a signal from the card reader 17, whether or not the IC card 20 has been detected by the card reader 17. When it is determined that the IC card 20 has been detected (S1: Yes), the processing proceeds to step S2. On the other hand, when it is determined that the IC card 20 has not been detected (S1: No), the process of step S1 is repeated until it is determined that the IC card 20 has been detected.

### Step S2

In step S2, the control portion 16 determines whether or not a certain time period P1 (an example of a “predetermined time period” of the present disclosure) has elapsed after it is determined in step Si that the IC card 20 has been detected. Then, when it is determined that the certain time period P1 has elapsed (S2: Yes), the processing proceeds to step S3. Meanwhile, when it is determined that the certain time period P1 has not elapsed (S2: No), the process of step S2 is repeated until it is determined that the certain time period P1 has elapsed.

### Step S3

In step S3, the control portion 16 determines a detection pattern of the IC card 20, on the basis of a signal from the card reader 17 in a period from the time when the IC card 20 has been detected in step S1 to the time when it is determined in step S2 that the certain time period P1 has elapsed. For example, the control portion 16 determines in which of the plurality of detection patterns included in the card operation information 30 shown in FIG. 3 the IC card 20 has been detected.

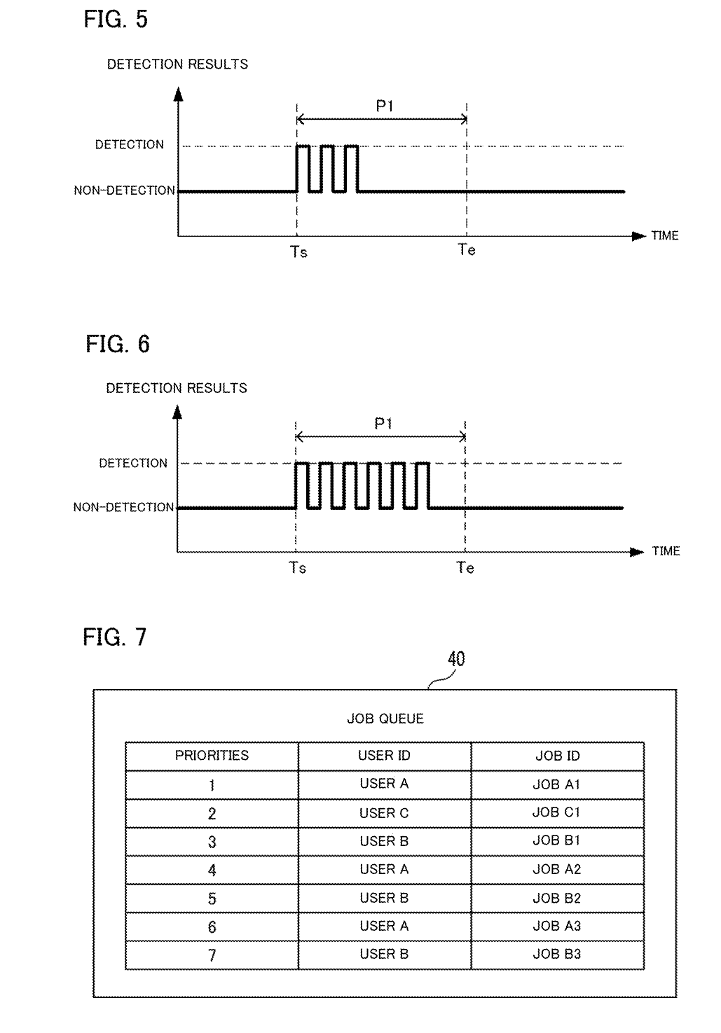

FIG. 5 and FIG. 6 each show an example of a signal from the card reader 17. In a period during which the IC card 20 has not been detected by the card reader 17, the signal from the card reader 17 is at L level. In a period during which the IC card 20 has been detected by the card reader 17, the signal from the card reader 17 is at H level.

In FIG. 5 and FIG. 6, a time Ts represents a timing when the IC card 20 has been detected in step S1, and a time Te represents a timing when it is determined in step S2 that the certain time period P1 has elapsed. FIG. 5 shows a signal from the card reader 17 when the IC card 20 (the same IC card 20) has been detected three times intermittently in the certain time period P1 from the time Ts. This means that the same IC card 20 has been held over the card reader 17 three times during the certain time period P1. FIG. 6 shows a signal from the card reader 17 when the same IC card 20 has been detected six times intermittently in the certain time period P1 from the time Ts. This means that the same IC card 20 has been held over the card reader 17 six times during the certain time period P1.

### Step S4

In step S4, the control portion 16 determines whether or not the same IC card 20 has been detected multiple times in a period from the time when the IC card 20 has been detected in step S1 to the time when it is determined in step S2 that the certain time period P1 has elapsed. When it is determined that the same IC card 20 has been detected multiple times (S4: Yes), the processing proceeds to step S5. Meanwhile, it is determined that the IC card 20 has been detected only once (S4: No), the processing proceeds to step S6.

### Step S5

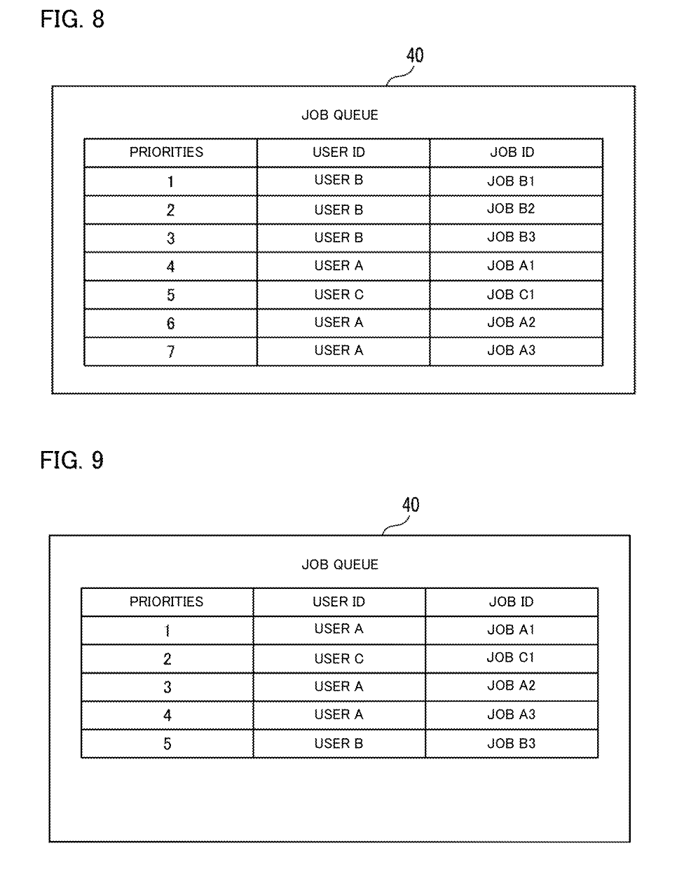

In step S5, the control portion 16 executes the process associated with the detection pattern determined in step S3 on the basis of, for example, the card operation information 30 shown in FIG. 3. For example, when the signal shown in FIG. 5 has been outputted from the card reader 17, the control portion 16 prioritizes all of the jobs of the user of the IC card 20 that has been held over the card reader 17. Specifically, when the user of the IC card 20 that has been held over the card reader 17 is user B, the control portion 16 sets the priorities of jobs B1, B2, and B3, of user B, which are included in the job queue 40 shown in FIG. 7, higher than the priorities of jobs of other users as shown in FIG. 8.

Moreover, for example, when the signal shown in FIG. 6 has been outputted from the card reader 17, the control portion 16 cancels two of the jobs of the user of the IC card 20 that has been held over the card reader 17. Specifically, when the user of the IC card 20 that has been held over the card reader 17 is user B, the control portion 16 cancels, for example, two jobs (i.e., jobs B1, B2) having the highest and second highest priorities among jobs B1, B2, and B3, of user B, which are included in the job queue 40 shown in FIG. 7. As a result, the job, of user B, which is included in the job queue 40 is only job B3 as shown in FIG. 9.

When the process of step S5 has been finished, the processing returns to step S1. In other embodiments, the processing may proceed to step S6 after the process of step S5 has been finished.

### Step S6

In step S6, the control portion 16 determines whether or not the IC card 20 is placed on the card placement table 18, on the basis of a signal from the card reader 17. When it is determined that the IC card 20 is placed on the card placement table 18 (SG: Yes), the processing proceeds to step S7. Meanwhile, when it is determined that the IC card 20 is not placed on the card placement table 18, the processing returns to step S1.

### Step S7

In step S7, the control portion 16 executes user authentication on the basis of the authentication information read from the IC card 20 by the card reader 17, and executes a login process.

### Step S8

In step S8, the control portion 16 determines whether or not the IC card 20 is placed on the card placement table 18 on the basis of a signal from the card reader 17. When it is determined that the IC card 20 is not placed on the card placement table 18 (S8: No), the processing proceeds to step S9. Meanwhile, when it is determined that the IC card 20 is placed on the card placement table 18 (S8: Yes), the process of step S8 is repeated until it is determined that the IC card 20 is not placed on the card placement table 18.

### Step S9

In step S9, the control portion 16 executes a logout process concerning the user who has logged in. Then, the processing returns to step S1.

It is noted that the processes of step S6 to step S9 are executed by the authentication processing portion 161 of the control portion 16. The processes of step S1 to step S5 are executed by the process execution portion 162 of the control portion 16.

As described above, the image processing apparatus 1 according to the present embodiment allows the user, by holding the IC card 20 over the card reader 17 a predetermined number of times in the certain time period P1, to set the priorities of his/her jobs higher or to cancel his/her jobs.

### Modification

Although, in the above embodiment, the priority of each job is changed or the job is cancelled in accordance with the detection pattern of the IC card 20, the present disclosure is not limited thereto. In other embodiments, any process may be executed in accordance with a detection pattern of the IC card 20.

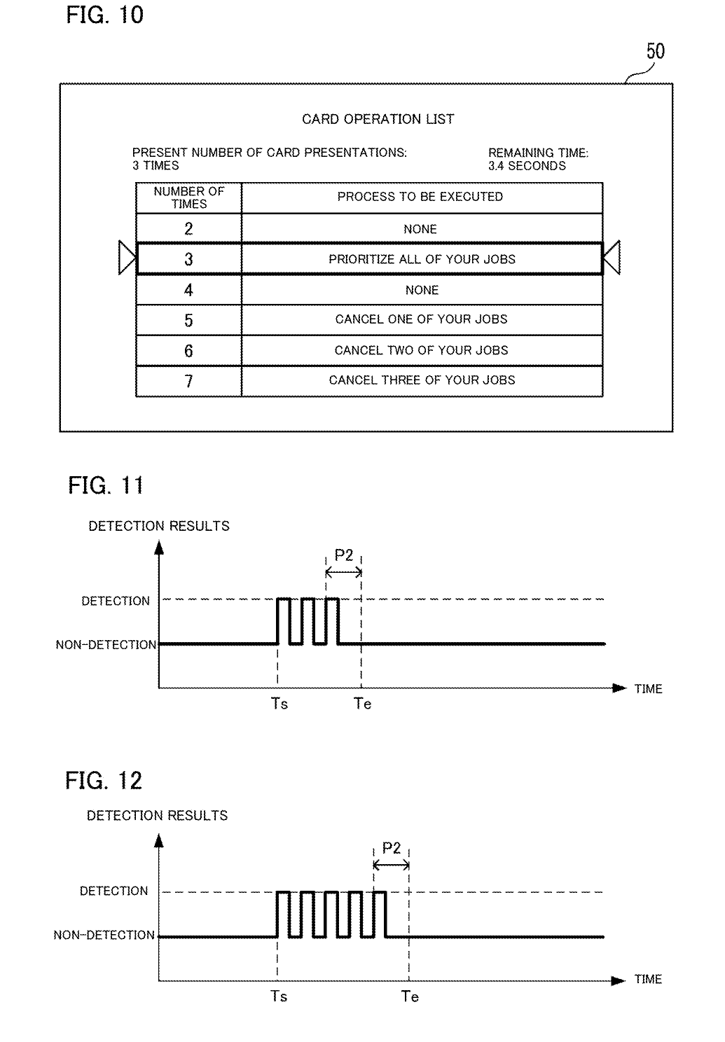

In other embodiments, in a period from a time when the IC card 20 has been detected by the card reader 17 to a time when the process (the process associated with the detection pattern) is executed by the process execution portion 162, the display control portion 164 may display information concerning the process on the operation display portion 10. For example, when the IC card 20 has been detected twice by the card reader 17, the display control portion 164 may display a card operation list screen 50 shown in FIG. 10 on the operation display portion 10. The card operation list screen 50 displays, for example, the number of times (the present number of times) the IC card 20 has been held over the card reader 17, the remaining time in the certain time period P1, the list of processes to be executed by the IC card 20 being held over the card reader 17 multiple times, and the like. This allows the user to understand that, by seeing the card operation list screen 50 shown in FIG. 10, for example, if the IC card 20 is not held over the card reader 17 anymore, all of his/her jobs will be executed preferentially. By seeing the card operation list screen 50 shown in FIG. 10, the user can understand that, for example, if the IC card 20 is held over the card reader 17 a further twice, one of his/her jobs will be cancelled.

In other embodiments, for example, when the IC card 20 has been detected twice by the card reader 17, the display control portion 164 may display the card operation list screen 50 shown in FIG. 10 on the operation display portion 10. When any of the plurality of processes displayed on the card operation list screen 50 shown in FIG. 10 has been touched by the user, the touched process may be executed. This allows the user, for example, instead of holding the IC card 20 over the card reader 17 seven times, to cancel three of his/her jobs by touching the card operation list screen 50 that is displayed after holding the IC card 20 twice over the card reader 17.

Although, in the above embodiment, the process associated with the detection pattern is executed in accordance with the detection pattern when the same IC card 20 has been detected by the card reader 17 multiple times intermittently in the certain time period P1, the present disclosure is not limited thereto. For example, in other embodiments, the process associated with the detection pattern may be executed in accordance with the detection pattern when the same IC card 20 has been detected by the card reader 17 multiple times intermittently without leaving a certain time period P2 (an example of a “predetermined time interval” of the present disclosure) between each time of the detection. FIG. 11 shows a signal from the card reader 17 when the same IC card 20 has been detected by the card reader 17 three times intermittently without leaving the certain time period P2 between each time of the detection. In this case, the control portion 16 is capable of determining a detection pattern at the time Te. FIG. 12 shows a signal from the card reader 17 when the same IC card 20 has been detected by the card reader 17 five times intermittently without leaving the certain time period P2 between each time of the detection. Also in this case, the control portion 16 is capable of determining a detection pattern at the time Te.

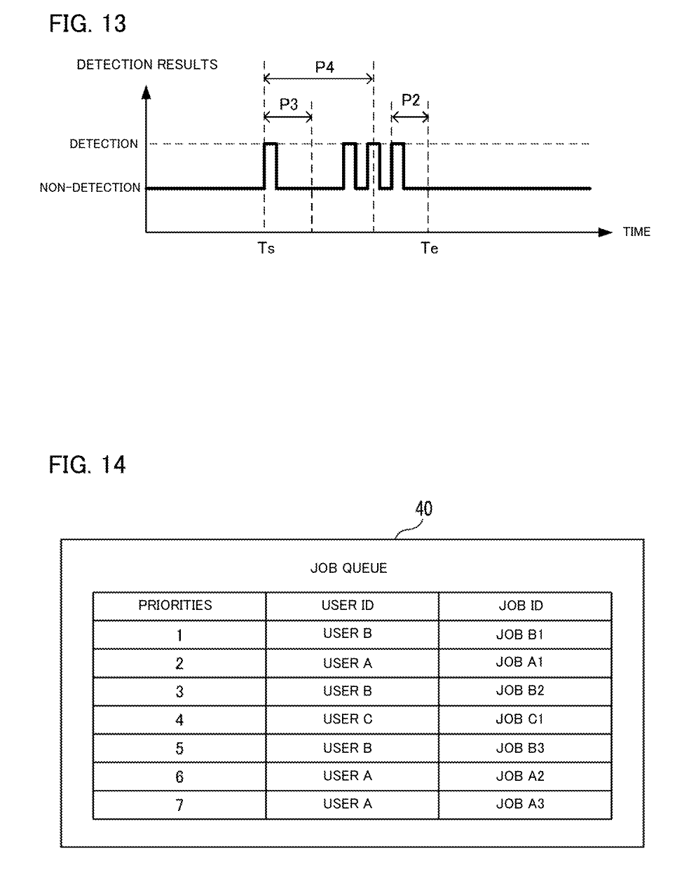

Although, in the above embodiment, the detection pattern of the IC card 20 is determined on the basis of the number of times of detection when the same IC card 20 has been detected by the card reader 17 multiple times intermittently, the present disclosure is not limited thereto. In other embodiments, the process execution portion 162 may determine the detection pattern on the basis of at least one of the number of times of detection and detection intervals when the same IC card 20 has been detected by the card reader 17 multiple times intermittently. For example, as shown in FIG. 13, when the same IC card 20 has been detected n times (here, N≧2) intermittently without leaving the certain time period P2 between each time of the detection, after a certain time period P3 has elapsed from the time Ts when the IC card 20 has been first detected (here, before the time when a certain time period P4 has elapsed from the time Ts), the process execution portion 162 may change the priority of the job of the user of the IC card 20 so as to increase the priority by (N−1) steps. For example, since N=3 in the example shown in FIG. 13, the priorities of the respective jobs of the user of the IC card 20 are changed so as to increase by two steps. As a result, for example, when the user of the IC card 20 that has been held over the card reader 17 is user B, the respective priorities of jobs B1, B2, and B3, of user B, which are included in the job queue 40 shown in FIG. 7 are changed so as to increase by two steps as shown in FIG. 14.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising:
a reader configured to detect an authentication medium in which authentication information is stored or displayed and read the authentication information from the authentication medium;
an authentication processor configured to execute user authentication on the basis of the authentication information read by the reader; and
a process executor configured to, when the same authentication medium has been detected by the reader multiple times in a predetermined detection pattern, execute a preset process associated with the detection pattern.

2. The image processing apparatus according to claim 1, wherein the detection pattern is a pattern in which the same authentication medium is detected by the reader multiple times intermittently in a predetermined time period.

3. The image processing apparatus according to claim 1, wherein the detection pattern is a pattern in which the same authentication medium is detected by the reader multiple times intermittently without leaving a predetermined time interval between each time of the detection.

4. The image processing apparatus according to claim 1, wherein the process executor determines the detection pattern on the basis of at least one of the number of times of detection and detection intervals when the same authentication medium has been detected by the reader multiple times intermittently.

5. The image processing apparatus according to claim 1, wherein, when the same authentication medium has been detected by the reader multiple times in any of a plurality of predetermined detection patterns, the process executor selects, from among a plurality of preset processes, the process associated with the detection pattern, and executes the process.

6. The image processing apparatus according to claim 1, wherein the preset process includes a process related to a user who is associated with the authentication information read by the reader.

7. The image processing apparatus according to claim 6, wherein the preset process includes a process of raising a priority of a job of the user who is associated with the authentication information read by the reader, among unfinished jobs to be done by the image processing apparatus.

8. The image processing apparatus according to claim 6, wherein the preset process includes a process of cancelling a job of the user who is associated with the authentication information read by the reader, among unfinished jobs to be done by the image processing apparatus.

9. The image processing apparatus according to claim 1, further comprising a display controller configured to display information concerning the preset process in a period from a time when the authentication medium has been detected by the reader to a time when the preset process is executed by the process executor.
